(19) United States
(12) Patent Application Publication
(10) Pub. No.: US 2013/0103539 A1
(43) Pub. Date: Apr. 25, 2013

(54) INTELLIGENT SHOPPING ASSISTANT

(71) Applicants: SUBIL M. ABRAHAM, PLANO, TX (US); RAJARAMAN HARIHARAN, BANGALORE (IN); RAMAKRISHNAN KANNAN, BANGALORE (IN); MATHEWS THOMAS, FLOWER MOUND, TX (US)

(72) Inventors: SUBIL M. ABRAHAM, PLANO, TX (US); RAJARAMAN HARIHARAN, BANGALORE (IN); RAMAKRISHNAN KANNAN, BANGALORE (IN); MATHEWS THOMAS, FLOWER MOUND, TX (US)

(73) Assignee: INTERNATIONAL BUSINESS MACHINES CORPORATION, ARMONK, NY (US)

(21) Appl. No.: 13/280,904

(22) Filed: Oct. 25, 2011

(51) Int. Cl. G06Q 30/00

(52) U.S. Cl. 705/26.8

(57) ABSTRACT

A method of on-premise customer support can include, responsive to logging a customer into a computerized shopping system on-premises of a store, recalling a shopping list associated with the customer. A route through the store can be generated automatically according to one or more items on the shopping list.

### BACKGROUND

One or more embodiments disclosed within this specification relate to an intelligent shopping assistant. Online commerce through shopping Websites has become increasingly popular. The evolution of online commerce has led to improvements in customer support as provided by the Websites and an improved shopping experience for the customers.

While online shopping technology has advanced, the shopping experience for those that shop on-premises at a store has remained largely unchanged. Customers typically stroll through the store selecting items of interest or actively pursuing items from a shopping list. Representatives of the store may not interact with the customer until the customer pays for selected items at a checkout station or the customer specifically asks a representative of the store for assistance.

### BRIEF SUMMARY

One or more embodiments disclosed within this specification relate to an intelligent shopping assistant.

An embodiment can include a method of on-premise customer support. The method can include, responsive to logging a customer into a computerized shopping system when on-premises of a store, recalling a shopping list associated with the customer. The method can include automatically generating, using a processor, a route through the store according to at least one item on the shopping list.

Another embodiment can include a method of collaborative shopping. The method can include associating a shopping list with each of a plurality of customers and determining that at least one of the plurality of customers has selected an item for purchase from the shopping list. Using a processor, synchronizing the shopping list among the plurality of customers associated with the shopping list.

Another embodiment can include a system for on-premise customer support and/or collaborative shopping. The system can include a processor configured to initiate executable operations as described within this specification.

Another embodiment can include a computer program product for on-premise customer support and/or collaborative shopping. The computer program product can include a computer readable storage medium having computer readable program code embodied therewith. The computer readable program code can include or specify instructions for performing the various functions and/or operations described within this specification.

### BRIEF DESCRIPTION OF THE SEVERAL VIEWS OF THE DRAWINGS

FIG. 1 is a block diagram illustrating a shopping assistance system (SAS) in accordance with one or more embodiments disclosed within this specification.

FIG. 2 is a block diagram illustrating an SAS master described with reference to FIG. 1 in accordance with another embodiment disclosed within this specification.

FIG. 3 is a block diagram illustrating an SAS client described with reference to FIG. 1 in accordance with another embodiment disclosed within this specification.

FIG. 4 is a flow chart illustrating a method of providing customer support in accordance with another embodiment disclosed within this specification.

FIG. 5 is a flow chart illustrating a method of providing customer support in accordance with another embodiment disclosed within this specification.

FIG. 6 is a flow chart illustrating a method of collaborative shopping in accordance with another embodiment disclosed within this specification.

FIG. 7 is a flow chart illustrating a method of providing customer support in accordance with another embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

One or more embodiments disclosed within this specification relate to an intelligent shopping assistant. In accordance with the inventive arrangements disclosed within this specification, shopping assistance can be provided to customers located on-premises at a store while shopping. A shopping assistance system can be implemented that can provide various levels of assistance to a customer. For example, the shopping assistance system can provide features such as intelligent route generation and dynamic updating or modification of the route according to selected route update conditions, notification of representatives of the store relating to various conditions, as well as collaborative shopping.

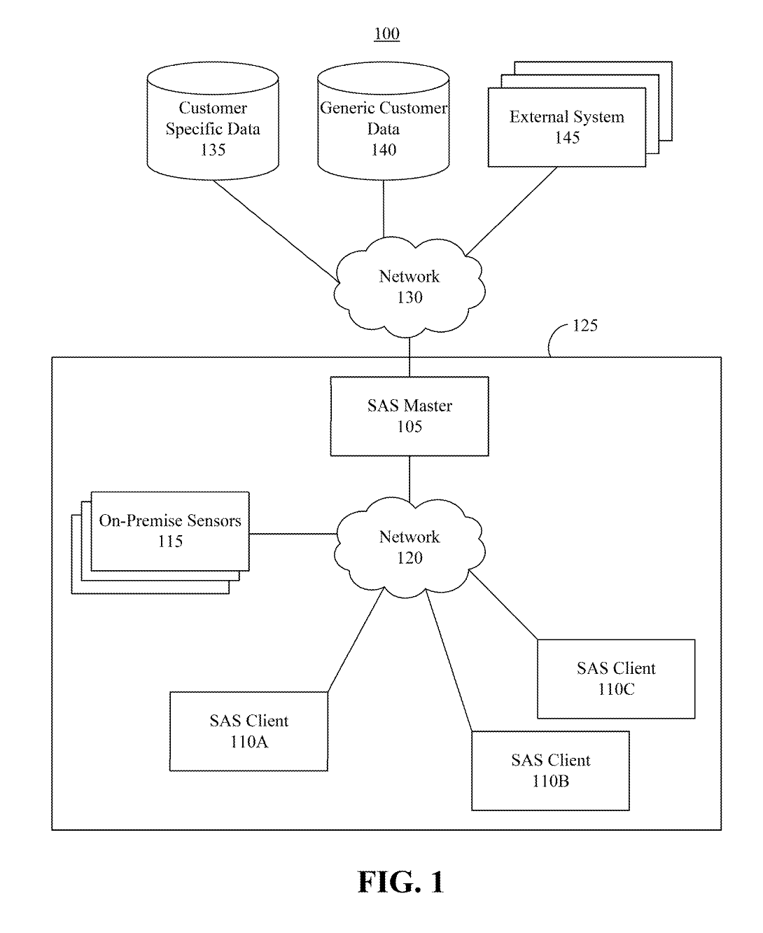

FIG. 1 is a block diagram illustrating a shopping assistance system (SAS) 100 in accordance with one or more embodiments disclosed within this specification. As shown, SAS 100 can include an SAS master 105, one or more SAS clients 110A, 110B, and 110C, and one or more on-premise sensors 115. In general, SAS master 105, SAS clients 110, and on-premise sensors 115 can be communicatively linked and communicate with each other through a network 120. Network 120 can be implemented as a wireless network or as a network that includes both wired and wireless connections.

SAS clients 110 can be implemented in the form of portable and/or mobile computing devices. In one aspect, an SAS client 110 can be implemented as a computing device that can be carried on the person of a customer that is on-premises of a business establishment or other organization that is selling goods and/or services (hereafter “store”). In another aspect, an SAS client 110 can be implemented as a computing device that can be mounted to a shopping cart. As known, a shopping cart, in general, refers to a bin or container typically on wheels that can be maneuvered around a store by a customer. The customer can place items selected for purchase into the shopping cart. The phrase “shopping cart,” as used herein, can include or refer to any of a variety of bins, baskets, or containers that can be pushed, pulled, or carried by a customer and within which goods and/or services can be placed. In another aspect, a shopping cart can refer to a bag carried by a customer.

Each of SAS clients 110A-110C can communicate with SAS master 105 via network 120 through wireless communication links. It should be appreciated that the particular number of SAS clients shown, in this case three, is for purposes of illustration only and is not intended as a limitation of the one or more embodiments disclosed within this specification. In this regard, SAS 100 can include fewer or more SAS clients 110 than illustrated in FIG. 1.

On-premise sensors 115 represent various sensors that can be placed throughout the store within which SAS 100 is implemented. On-premise sensors 115 can be sensors that can be considered common to more than one consumer, e.g., all consumers, within the store and that are located or installed on-premises or collect data relating to on-premise activities, e.g., customer activities. In one aspect, one or more on-premise sensors 115 can sense values that can be associated with particular ones of the SAS clients 110A-110C, e.g., by SAS master or through analysis of data received from multiple ones of on-premise sensors 115. It should be appreciated that on-premise sensors 115, while illustrated in a particular location as a group, can be strategically located throughout the store.

Examples of on-premise sensors 115 can include, but are not limited to, cameras configured to capture still images, cameras configured to capture video, microphones configured to capture audio, scales configured to weigh items placed on top of the scale, radio frequency identification (RFID) tag readers, bar code scanners, etc. A camera type of on-premise sensor 115, for example, can be positioned overhead, e.g., from a ceiling or a wall. A scale type of on-premise sensor 115 can be located in the floor of the store so that a shopping cart can be weighed as the shopping cart passes over the scale. Depending upon the particular type of on-premise sensor 115 that is used and the location at which the on-premise sensor 115 is implemented, on-premise sensors 115 can communicate with SAS master 105 via a wired or a wireless connection, e.g., communication link.

The outline labeled 125 within FIG. 1 can represent the physical bounds or confines of the store in which SAS 100 is implemented or operational. In this regard, SAS clients 110 and on-premise sensors 115 can be located within and throughout the physical bounds of the store. In one aspect, SAS master 105 can be located on-premises with SAS clients 110 and on-premise sensors 115. In another aspect, however, SAS master 105 can be located off premises of the store, e.g., outside of bounds 125.

SAS master 105 can be communicatively linked through a network 130 with one or more other systems and/or data storage nodes. For example, as illustrated in FIG. 1, SAS master 105 can be communicatively linked to customer specific data 135, generic customer data 140, and one or more external systems 145. As pictured, customer specific data 135, generic customer data 140, and external systems 145 can be located off premises of the store. It should be appreciated, however, that the one or more embodiments disclosed within this specification are not so limited. One or more or all of elements 135, 140, and 145 can be located on-premises depending upon the implementation of SAS 100.

Customer specific data 135 can represent a data storage node or a data storage system that stores data specific to individual customers of the store. In one aspect, customer specific data 135 can include items of information attributable to, or associated with, particular customers of the store. In general, customer specific data 135 can be collected using internal systems of the store such as SAS 100, point of sale (POS) systems or checkout stations, inventor management systems, or the like. Examples of the type of data that can be stored in association with each customer can include, but is not limited to, customer identifying information, a current shopping list for the customer, prior shopping data such as items purchase during prior visits to the store, the time, date, and duration of prior visits to the store, routes taken through the store during such prior visits, and the like.

Regarding prior shopping data, for example, customer specific data 135 can specify, on a per visit basis, the date and time of the visit, the amount of time the customer was within the store, the route taken through the store, the items purchased, and a timing of the route indicating the amount of time spent by the customer at various locations or points along the route traversed by the customer. It should be appreciated that location data can be correlated with departments of the store or subject matter domains indicating types of items sold in the particular locations along the route within the store.

Customer specific data 135 also can include information that can be collected or obtained from an electronic commerce Website or other backend-type of system of the store. Additional examples of customer-specific data 135 can include, but are not limited to, customer provided shopping preferences, a wish list specifying items desired by the customer, promotions offered to the customer that were redeemed, promotions offered to the customer that were not redeemed, etc.

Generic customer data 140 can represent a data storage node or a data storage system that stores data corresponding to multiple customers of the store in general. For example, generic customer data 140 can specify shopping trends of customers in general, volume sales on particular days, at particular times, for particular items, or the like. In another aspect, generic customer data 140 can include data relating to the layout of the store that defines paths, e.g., a map, that can be traversed in the store by customers, the location of various departments or products as correlated with the map, whether specifically or by product type, and the like.

For example, generic customer data 140 can include a planogram for the store. A planogram refers to a diagram of fixtures and products of the store that illustrates how and where the products are displayed, e.g., particular store shelves, aisles, etc. It further should be appreciated that the generic customer data 140 can specify or include data for one or more different store locations and that any data maintained in the generic customer data 140 can be specified on a per location basis.

External systems 145 can represent one or more systems that are considered external to the store, but can be accessed by SAS master 105. An external system 145 can include any system that provides information that is not specific to the particular store utilizing SAS 100. For example, an external system 145 can be a system that is configured to provide current weather conditions to SAS master 105 or a forecast of weather conditions for a predetermined period of time into the future, e.g., in the next 5, 10, 15, 20, 25, or 30 minutes. In this regard, a system can be considered “external” in that the information provided is not part of the core business of the store and does not originate from within the store. For example, an inventory management system of the store can be considered part of the generic customer data 140 and may not be considered an external system 145, whereas a system that provides current financial market data would be an example of an external system 145.

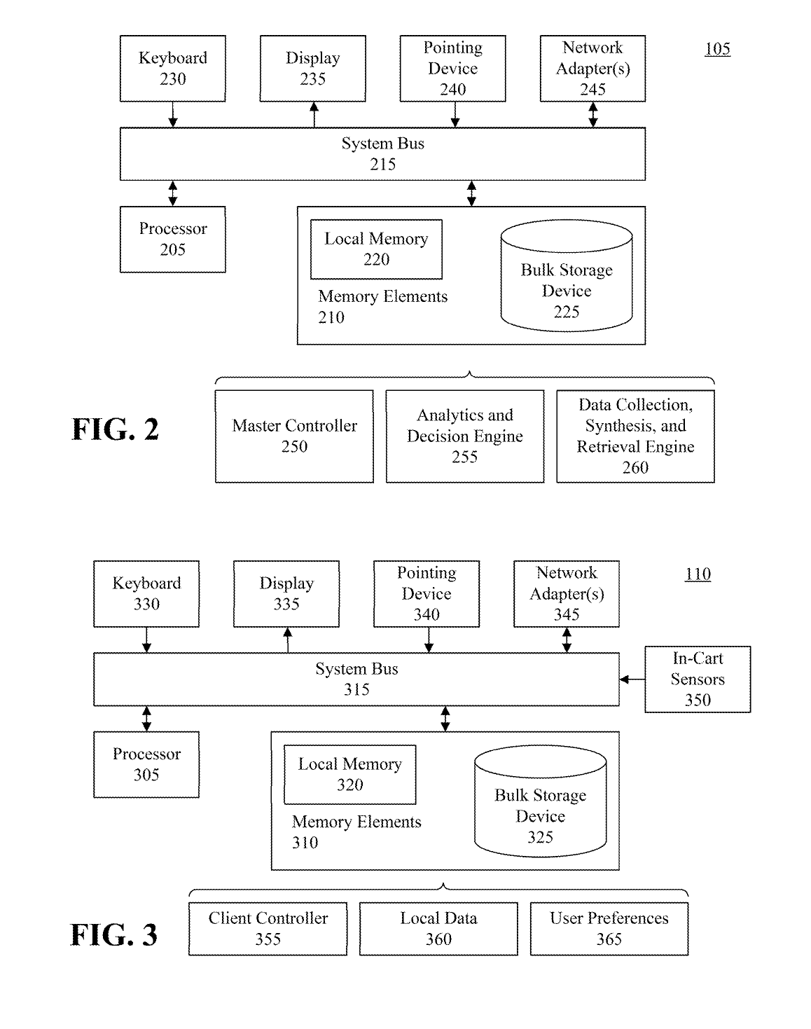

FIG. 2 is a block diagram illustrating an SAS master 105 in accordance with another embodiment disclosed within this specification. Like numbers will be used to refer to the same items throughout this specification. SAS master 105 can include at least one processor 205 coupled to memory elements 210 through a system bus 215 or alternative connection arrangement. As such, SAS master 105 can store program code within memory elements 210. Processor 205 can execute the program code accessed from memory elements 210 via system bus 215. In one aspect, for example, SAS master 105 can be implemented as a computer, e.g., a server, that is suitable for storing and/or executing program code. It should be appreciated, however, that SAS master 105 can be implemented in the form of any system including a processor and a memory that is capable of performing the functions described within this specification.

Memory elements 210 can include one or more physical memory devices such as, for example, local memory 220 and one or more bulk storage devices 225. Local memory 220 refers to RAM or other non-persistent memory device(s) generally used during actual execution of the program code. Bulk storage device(s) 225 can be implemented as a hard drive or other persistent data storage device such as an SSD, e.g., a flash memory, or the like. SAS master 105 also can include one or more cache memories (not shown) that provide temporary storage of at least some program code in order to reduce the number of times program code must be retrieved from bulk storage device 225 during execution.

Input/output (I/O) devices such as a keyboard 230, a display 235, and a pointing device 240 optionally can be coupled to SAS master 105. The I/O devices can be coupled to SAS master 105 either directly or through intervening I/O controllers. Network adapter(s) 245 also can be coupled to SAS master 105 to enable SAS master 105 to become coupled to other systems, computer systems, remote printers, routers, and/or remote storage devices through intervening private or public networks. Modems, cable modems, Ethernet cards, and wireless transceivers, are examples of different types of network adapters that can be used with SAS master 105.

As shown, SAS master 105 can include various processing modules in the form of computer program code that can be executed by processor 205. For example, SAS master 105 can include a master controller 250, an analytics and decision (AD) engine 255, and a data collection, synthesis, and retrieval (DCSR) engine 260. In general, master controller 250 can be configured to coordinate the activities of AD engine 255 and DCSR engine 260. Further, master controller 250 can be configured to communicate with other components of SAS 100. For example, master controller 250 can receive data from on-premise sensors 115, customer specific data 135, generic customer data 140, and external systems 145. Master controller 250 also can be configured to receive queries from SAS clients 110 and send responses to SAS clients as determined or calculated using AD engine 255 and DCSR engine 260.

DCSR engine 260 can be configured to store and organize data received from SAS clients 110, on-premise sensors 115, customer specific data 135, generic customer data 140, and external systems 145. In one aspect, DCSR 260 can correlate any data not initially associated with a customer, e.g., sensor data, with a particular customer using, for example, location of the customer and the location of the particular on-premise sensor 115 from which the data was received. AD engine 255 can analyze received data and determine one or more actions based upon the analysis performed. Master controller 250 can facilitate the execution of the determined action through coordination between AD engine 255, DCSR engine 260, communication with on-premise sensors 115, and communication with SAS clients 110. In general, master controller 250, AD engine 255, and DCSR engine 260, as executed within SAS master 105, can perform or implement the various operations described within this specification attributable to SAS master 105.

FIG. 3 is a block diagram illustrating an SAS client 110 in accordance with another embodiment disclosed within this specification. SAS client 110 can include at least one processor 305 coupled to memory elements 310 through a system bus 315 or alternative connection arrangement. As such, SAS client 110 can store program code within memory elements 310. Processor 305 can execute the program code accessed from memory elements 310 via system bus 315. In one aspect, for example, SAS client 110 can be implemented as computer, e.g., a mobile or portable computing device, suitable for storing and/or executing program code. It should be appreciated, however, that SAS client 110 can be implemented in the form of any system including a processor and a memory that is capable of performing the functions described within this specification.

Memory elements 310 can include one or more physical memory devices such as, for example, local memory 320 and one or more bulk storage devices 325. Local memory 320 refers to RAM or other non-persistent memory device(s) generally used during actual execution of the program code. Bulk storage device(s) 325 can be implemented as a hard drive or other persistent data storage device such as an SSD, e.g., a flash memory, or the like. SAS client 110 also can include one or more cache memories (not shown) that provide temporary storage of at least some program code in order to reduce the number of times program code must be retrieved from bulk storage device 325 during execution.

Input/output (I/O) devices such as a keyboard 330, a display 335, a pointing device 340, and one or more in-cart sensors 350 optionally can be coupled to SAS client 110. In one aspect, display 335 can be implemented as a touch sensitive display. When implemented as a touch sensitive display, display 335 can provide functionality of keyboard 330 and pointing device 340. As such, keyboard 330 and pointing device 340 may not be included as the customer can interact with SAS client 110 via display 335. Examples of in-cart sensors 350 that can be incorporated within, or coupled to, SAS client 110 can include, but are not limited to, a bar code reader or scanner, an RFID reader, an RFID tag, a card reader configured to read a magnetic strip of a customer loyalty card or other identifying card of the customer, a near-field communications (NFC) chip or integrated circuit configured to communicate with other NFC enabled cards or devices, etc.

The I/O devices can be coupled to SAS client 110 either directly or through intervening I/O controllers. Network adapter(s) 345 also can be coupled to SAS client 110 to enable SAS client 110 to become coupled to other systems, computer systems, remote printers, routers, and/or remote storage devices through intervening private or public networks. An example of a network adapter can be a wireless transceiver.

As shown, SAS client 110 can include various processing modules in the form of computer program code that can be executed by processor 305. For example, SAS client 110 can include a client controller 355, local data 360, and customer preferences 365. Client controller 355 can be implemented as an application program that can be configured to control operation of the various elements of SAS client 110, e.g., in-cart sensors 350, network adapter 345, and the like.

Local data 360 can represent data collected by in-cart sensors 350 as well as any shopping cart-specific or customer-specific information that may be received from the SAS master, including route information. User preferences 365 can include any customer specified preferences that may be received either directly from the customer, e.g., via an I/O device of SAS client 110, or from the SAS master.

Referring collectively to FIGS. 1-3, SAS 100 can continually determine the location of a customer within the store, e.g., determine the location of a particular SAS client 110 associated with a customer. An identifier such as an RFID tag associated with, or included within, SAS client 110 can be detected by various on-premise sensors 115 located throughout the store. The on-premise sensors 115 can provide information specifying the particular SAS clients 110 detected. For example, a particular RFID tag for a shopping cart that is detected at a specific location can be correlated with a particular SAS client and customer, thereby allowing SAS master 105 to continually determine the location of each SAS client 110 within the store with reference to the map or planogram. By determining the current location of SAS clients 110, the path or route taken by each SAS client 110 also can be determined through the store, the time spent at various points along the route, etc.

It should be appreciated that other location determination techniques can be used in combination with RFID tag technology or as alternatives. For example, the location of a customer can be determined using techniques including, but not limited to, triangulation, whether using RFID or other wireless communications technologies, Global Positioning System (GPS), video analysis, facial recognition, etc. In this regard, the one or more embodiments disclosed within this specification are not intended to be limited to the particular examples provided.

In another aspect, SAS 100 can facilitate item tracking within the store. SAS client 110 can determine the particular items placed into a shopping cart. As noted, when an RFID reader is used as an in-cart sensor, SAS client 110 can automatically determine the particular items placed into the shopping cart of a customer presuming that such items are coupled to an RFID tag. In other cases, e.g., when a bar code scanner is in-cart sensor 350, identification of items placed in the shopping cart can require manual scanning or other deliberate action by the customer.

SAS 100 also can determine shopping cart level data that indicates how full or empty a given shopping cart is at any given time. In one aspect, shopping cart level data can be determined using on-premise sensors 115, e.g., a weigh scale. Video capture and/or analysis can be used to determine cart level data. In another aspect, SAS client 110 can determine a measure of how full or empty the shopping cart is by identifying the items placed into the shopping cart and determining the physical properties of the items, e.g., dimensions and/or weight, from an inventory management system or other product database for the store as compared to the capacity of the shopping cart itself.

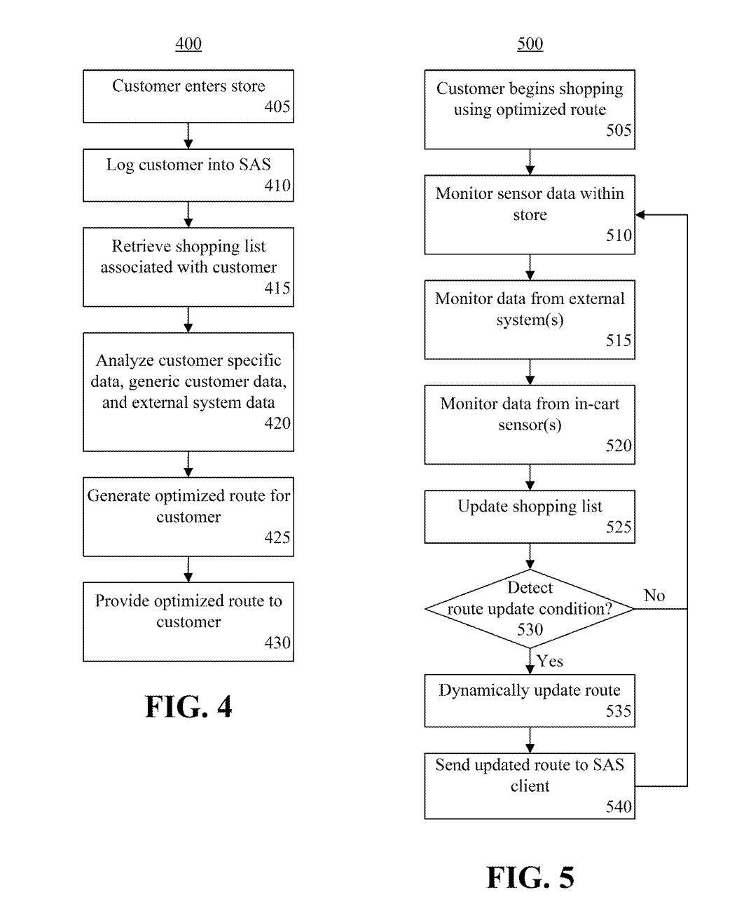

FIG. 4 is a flow chart illustrating a method 400 of providing customer support in accordance with another embodiment disclosed within this specification. More particularly, FIG. 4 illustrates a technique for generating a route for a customer that can be followed by the customer when on-premises of the store. FIG. 4 can be implemented using the SAS described with reference to FIGS. 1-3 of this specification. In general, the SAS can follow a paradigm in which data is collected, analysis is performed, and one or more actions are determined. The data can be collected, for example, in real time. “Real time” can refer to a level of processing responsiveness that a user or system senses as sufficiently immediate for a particular process or determination to be made, or that enables the processor to keep up with some external process. Analysis attempts to predict actions of the customer and provide the customer with an increased level of customer satisfaction through initiation of one or more actions.

Method 400 can begin in step 405 where a customer enters a store in which an SAS has been implemented. In step 410, the SAS can log the customer into the SAS. For example, the customer can obtain an SAS client upon entering the store. The SAS client can be a mobile unit that can be carried by the customer or can be a mobile unit that is coupled to a shopping cart to be used by the customer while on-premises of the store. The customer can log into the SAS via an interface of the SAS client, by swiping a card in the SAS client, using NFC technology, or the like. The SAS client can communicate identifying information for the customer to the SAS master, which can log-in the customer. The particular way in which the customer logs into the SAS is not intended to limit the one or more embodiments disclosed within this specification.

In step 415, the SAS can retrieve a shopping list associated with the customer. For example, prior to visiting the store, the customer can upload a shopping list to the SAS. The shopping list can be uploaded via a Website for example, and be associated with the customer within the customer specific data. Upon logging into the SAS via the SAS client, the SAS client can issue a request to the SAS master for the shopping list. The SAS master can retrieve the shopping list, e.g., from the customer specific data.

In step 420, the SAS can analyze the customer specific data inclusive of the shopping list, the generic customer data, and external system data that may be available. In step 425, the SAS can generate an optimized route for the customer through the store. More particularly, the SAS master can generate the optimized route. The route can be a path through the store that, at least in part, takes the customer past one or more or all of the items on the shopping list associated with the customer.

For example, the SAS can generate a route that is optimized in terms of reducing the amount of time the customer will be in the store, e.g., generate a route that is short or shortest in length that takes the consumer past each of the items on the shopping list. In another example, in addition to passing by items on the shopping list, the optimized route can be one that takes the consumer past items that are currently on sale in the store that the customer has purchased in the past and which are not on the shopping list. In still another example, in addition to passing by items on the shopping list, the route can be one that is longer and takes the customer past one or more other items not on sale and not on the shopping list.

The determination whether to generate a shorter length route or a longer length route, as described above, can be made using any of a variety of different techniques. In one aspect, the determination can be based upon time of day and/or day of the week. Time information, referring to the time of the customer's visit, can indicate whether the customer is likely in a hurry. For example, when the SAS determines that the customer is visiting at a particular time within a predefined time range identified as a “rush hour,” the SAS can determine that the customer is likely in a hurry and select the shortest length route. In another example, when the SAS determines that the customer is visiting at a time determined to be a non-rush hour time, e.g., on a weekend, the SAS can determine that the customer is not likely in a hurry and select a longer length route, e.g., a route that takes the customer past one or more additional items not on the shopping list.

In step 430, the SAS can provide the optimized route to the customer. For example, the SAS master, having generated the route, can forward the route to the customer. In one aspect, the route can be specified to the customer with real time directions as the customer traverses the route. In another aspect, a map of the route with respect to the store can be presented to the customer. The current location of the customer on the route can be shown with customer movement and progress on the route being indicated in real time or near real time. The SAS master further can provide the shopping list to the SAS client for presentation or display to the customer. Identifiers can be displayed along the route to indicate the respective locations of items from the shopping list.

In another aspect, as the customer moves through the store, the SAS can attempt cross-sells and/or up-sells. For example, when the customer is determined to be close to a cross-sell item, the SAS master can instruct the SAS client to display an advertisement or notification to facilitate the cross-sell. A similar or same technique of displaying an advertisement or notification to the customer through the SAS client can be performed to facilitate an up-sell. For example, an up-sell or a cross-sell message for an item can be provided responsive to the customer placing the item in the shopping cart.

FIG. 5 is a flow chart illustrating a method 500 of providing customer support in accordance with another embodiment disclosed within this specification. More particularly, FIG. 5 illustrates a technique that can be used to dynamically update or modify a route for a customer while the customer continues to shop on-premises at a store. FIG. 5 can be implemented using the SAS described with reference to FIGS. 1-4 of this specification.

In step 505, the customer can begin shopping using the optimized route determined as described in FIG. 4. In step 510, the SAS master can monitor on-premise sensor data within the store. On-premise sensor data received from one or more of the on-premise sensors of FIG. 1 can be received and correlated with the customer. For example, camera data can be correlated with the customer based upon location data for the customer as correlated with the location of the camera or the location of the area within the store upon which the camera is focused. Using location data for the various SAS clients, on-premise sensor data can be correlated with the correct customer or SAS client as the case may be.

In step 515, the SAS master can monitor data received from one or more external systems such as weather data, financial market data, or the like. In step 520, the SAS master can monitor data from the in-cart sensors for the customer. As noted, the SAS client can include one or more in-cart sensors such as RFID readers, bar code scanners or the like. In this regard, the SAS client can determine the contents in the shopping cart of the customer and report the contents to the SAS master. In the case where the SAS client includes an RFID reader and items within the store have RFID tags, the contents of the shopping cart can be determined automatically by the SAS client. In the case where the SAS client utilizes a bar code scanner, manual scanning of items as each item is placed into the shopping cart and/or removed from the shopping cart by the customer is required.

In step 525, the SAS master can update the shopping list for the customer according to which items have been placed into the shopping cart and which items have been removed from the shopping cart as the customer traverses the route. Any item determined to be located within the shopping cart per the SAS client can be removed from the shopping list. Any items that are not in the shopping cart can remain on the shopping list. In one aspect, each item added to the shopping cart and/or removed from the shopping cart can be communicated from the SAS client to the SAS master. The SAS master, for example, can maintain an up to date shopping list that reflects which items have been selected for purchase by the customer, e.g., placed into the shopping cart, and which have not. The current state of the shopping list can be communicated back from the SAS master to the appropriate SAS client.

In step 530, the SAS master can determine whether a route update condition has been detected. Responsive to detecting a route update condition, method 500 can continue to step 535. Responsive to determining that a route update condition has not been detected, method 500 can loop back to step 510 to continue monitoring as described.

A route update condition can include or specify any of a variety of different situations responsive to which the SAS master updates or modifies the route of a customer. In one example, the route update condition can be a determination by the SAS master that the route of the customer traverses through an area within the store considered to be congested or a high traffic area. A congested or high traffic area can be one that includes more than a minimum number of SAS clients or people within a predetermined area. As such, whether an area is congested can change over time and be determined dynamically by the SAS master. The SAS master can dynamically update the route of the customer to avoid the congested area or, for example, an area determined to be on in which a hazardous condition has developed, e.g., a spill.

Another route update condition can include detection by the SAS master of an up-sell or cross-sell opportunity exists for the customer. Responsive to determining that the customer can be up-sold or cross-sold, the SAS master can dynamically update the route so that the customer passes by the item for which the customer is to be cross-sold or up-sold.

Another route update condition can include detection by the SAS master that a “high value” item has been placed into the shopping cart of the customer. Responsive to determining that the customer has placed a high value item in the shopping cart, e.g., an item having a value greater then a minimum predetermined value, the SAS master can dynamically change the route of the customer to bring the customer to the checkout location or aisle faster than otherwise would be the case had the route not been modified. For instance, the route can be dynamically modified to bring the customer immediately to the checkout using a path that is more direct than the original route.

In some instances, the dynamic modification of the route responsive to high value items can be limited to those cases in which the customer information indicates a likelihood that is greater than a predetermined minimum likelihood the customer will remove the item from the shopping cart. For example, the SAS master can process, historical data for the customer or generic customer data to determine a probability that the customer will remove the high value item from the shopping cart. Responsive to determining that the probability of removing the high value item from the shopping cart exceeds a threshold probability, the SAS master can modify the route to specify a faster or more direct path to a checkout station to increase the likelihood that the customer will purchase the high value item.

Another route update condition can include detection of particular external conditions, e.g., conditions in existence outside of the store as can be determined from analysis of data from one or more of the external systems. The SAS master, for example, can identify a condition that would prevent the consumer from leaving the store such as a particular weather condition. One example of a weather condition can include determining that the weather is currently poor, e.g., detecting precipitation such as rain, snow, sleet, and/or hail outside of the store, the forecast indicates poor weather within a predetermined amount of time, e.g., within the next 5, 10, 15, 20, or 25 minutes, or the like. In response to detecting a predetermined external condition, the SAS master can dynamically update the route. For example, a route that had been optimized for shortest length and/or minimum time can be modified, e.g., lengthened, to take the customer past one or more additional items for sale in the store while the poor weather persists.

Another route update condition can include detecting or receiving one or more predetermined parameters, e.g., customer-specific parameters of the customer, as entered into the SAS master by a representative of the store. As an example, a representative can take note that a particular customer is accompanied by another individual such as another customer, a child, etc. Responsive to that information being placed into the SAS, the SAS master can update the route of the customer. For example, if accompanied by a small child, the SAS master can update the route to optimize for reduced route length or reduced route time, update the route to pass by child care products, age-appropriate products for the child, gender-appropriate products for the person accompanying the customer, etc. While representatives can freely add information to the SAS, in another aspect, the SAS can be configured to query representatives for additional information responsive to predetermined conditions, e.g., the customer logging into the SAS.

Another route update condition can include detecting or matching a current location of the customer with historical route data for the customer. For example, based on historic location data of the customer, the SAS master can determine that the customer's last stop within the store typically is the grocery department. The SAS master, responsive to determining that the customer is in the grocery department of the store, can update the remaining portion of the route of the customer, e.g., the exit path toward the checkout station. A particular checkout station, for example, can be selected. In one aspect, the particular checkout station that is selected can be made according to the schedule of representatives manning the checkout stations. For example, the customer can be directed to a checkout station of a first representative so as to avoid a second representative that is scheduled to go on break. The route also can be updated to direct the customer to a checkout station that has a particular promotion item determined to be of interest to the customer.

Still another route update condition can include detection by the SAS master that the cart level of the customer is near full indicating the completion, or near completion of the shopping trip. Similarly, near completion or completion of the shopping list can be a route update condition. In either case, for example, the SAS can update the route in accordance with the exit path options discussed above.

In step 535, the SAS master can dynamically update or modify the route. For example, the SAS master can determine a new or updated route for the customer based upon any changing conditions detected with respect to the store, the data from the external systems, the current state of the shopping list, etc., as described within this specification. In step 540, the SAS master can send the updated or modified route to the customer by way of the SAS client. As shown, method 500 can loop back to step 510 to continue monitoring for various conditions and continually update the route of the customer until an exit condition is reached, e.g., the customer checks out, leaves the store, or the session for the customer is terminated within the SAS, whether by the customer or a representative of the store.

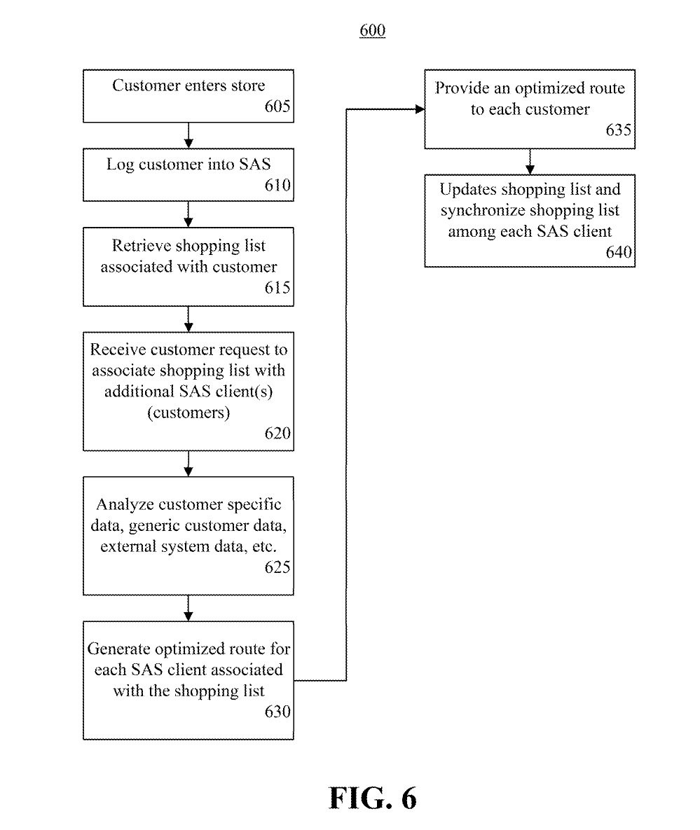

FIG. 6 is a flow chart illustrating a method 600 of collaborative shopping in accordance with another embodiment disclosed within this specification. FIG. 6 can be implemented using the SAS described with reference to FIGS. 1-5 of this specification.

In step 605, a customer can enter the store. The SAS, e.g., the SAS master, can log-in the customer in step 610. In step 615, the SAS can retrieve a shopping list associated with the customer. In step 620, the SAS can receive a request to associate the shopping list with one or more additional customers. For example, one or more persons accompanying the customer can log into the SAS, obtain SAS clients, and become associated with the shopping list that was retrieved via the SAS master.

In step 625, the SAS master can again analyze customer specific data inclusive of the shopping list, generic customer data, external system data, and the like. It should be appreciated that the evaluation of customer specific data can include any available customer specific data for each of the customers associated with the shopping list. Accordingly, in step 630, the SAS master can generate an optimized route, e.g., a different route, for each of the customers associated with the shopping list, e.g., each SAS client that is associated with the shopping list. Each of the routes can be tailored for the particular customer intended to traverse the route. Further, the items from the shopping list can be apportioned to the various routes so that the shopping list is completed by the cumulative effort of each customer associated with the shopping list.

In illustration, consider the case in which a family of three enters the store with a shopping list. Each member of the family can obtain an SAS client and begin shopping using the shopping list and the assigned route. Routes can be generated by the SAS using various parameters as discussed so that, for example, the parent is given a more complex route, a younger child is given a less complex route, e.g., a more direct route, a child can be routed to avoid the candy department or aisle, a child can be directed to a reading or play area when finished or to another designated rendezvous point also on the parent's route, etc. Each route can take the customer past only the subset of items from the shopping list for which that customer is responsible. Further, in another aspect, each customer can be presented with only the subset of items for the shopping list for which that customer is responsible through the respective SAS clients.

In step 635, the SAS master can provide an optimized route to each customer, e.g., to each of the SAS clients associated with the customer. In step 640, the SAS can update the shopping list and synchronize the shopping list among each of the SAS clients associated with the shopping list. For example, the shopping list can be updated so that as items are placed into a shopping cart of one or more of the customers, the items are removed from the shopping list.

Method 600 illustrates one example of a collaborative shopping experience that can be facilitated using the SAS. Other implementations for collaborative shopping also can be implemented. For example, a family can begin shopping together and, at some point during the shopping trip, a second SAS client can be selected and associated with the shopping list so that the family splits up to continue with the shopping trip to obtain items on the shopping list. Ultimately, the two SAS clients can arrive at the same checkout station. Alternatively, each of the customers, though sharing a same shopping list, can check out independently of one another.

Another example of a collaborative shopping experience can include the case in which multiple customers choose to have a collaborative experience. More particularly, two customers that are acquaintances or friends can choose to shop together. Each of the two customers can be associated with a different shopping list. When a first of the two customers places an item within the shopping cart, the second of the two customers is notified of the selected item. The second customer can be given the option, through the SAS client, to add the item selected by the first customer to the shopping list of the second customer. The two customers can collaborate despite not being physically located next to one another, but still on-premises within the store.

In another example, the collaborative shopping experience can be extended beyond a single store or location to include multiple stores or multiple locations of a same store. In that case, the SAS can notify a customer that an item is available for less money at another store or location. In that case, the customer can choose to remove the item from the shopping list and add the item to the shopping list of the collaborative shopping partner that is at the other store or location.

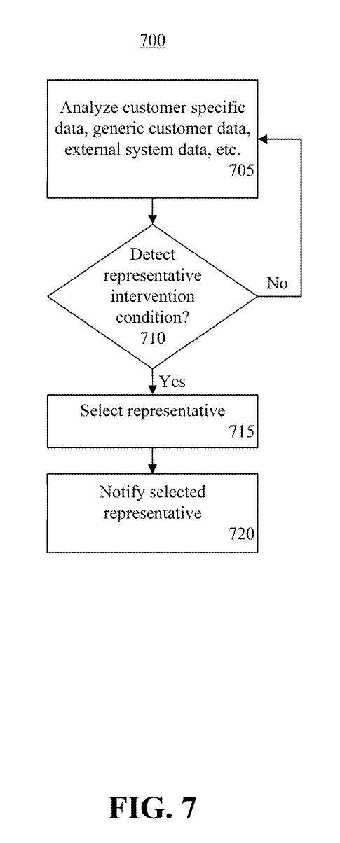

FIG. 7 is a flow chart illustrating a method 700 of providing customer support in accordance with another embodiment disclosed within this specification. FIG. 7 can be implemented using the SAS described with reference to FIGS. 1-6 of this specification. Method 700 illustrates a technique for providing support to customers through improved management and assignment of representatives of the store to the customer using the SAS. Method 700 can begin in a state where the customer has already logged into the SAS and has started shopping, e.g., traversing a route.

In step 705, the SAS master can analyze customer specific data, generic customer data, external system data, etc. In step 710, the SAS master can determine whether a representative intervention condition is detected for the customer. Responsive to detecting a representative intervention condition, method 700 can proceed to step 715. Responsive to determining that a representative intervention condition has not been detected, method 700 can loop back to step 705 to continue processing.

In one example, a representative intervention condition can refer to detection of a particular type of customer behavior or behavioral pattern. A representative intervention condition, for example, can specify how the customer is interacting with items in the store. In illustration, a representative intervention condition can include the placement of a high value item within the shopping cart of the customer. In another example, the representative intervention condition can include the customer first placing a high value item within the shopping cart and then removing the high value item from the shopping cart indicating that the customer likely needs assistance. Another example can include removal of the high value item from the shelf, e.g., where the shelf includes a sensor configured to detect removal of the item from the shelf coupled with one or more other on-premise sensors capable of identifying the customer responsible for removal of the item from the shelf.

In another example, a representative intervention condition can include a determination by the SAS that the customer has paused for more than a minimum amount of time at a particular location within the store, e.g., near an item on the shopping list, indicating that the customer is having difficulty making a decision or locating the item on the shelf. Conversely, the SAS determining that a customer has passed by a selected item too quickly, e.g., in less than a predetermined amount of time considered a minimum to consider purchase of an item or to place the item in the shopping cart, can be another example of a representative intervention condition. The selected item, for example, can be an on-sale item or an item on the customer's shopping list that was not placed in the shopping cart.

In step 715, the SAS master can select a particular representative to help the customer. In one aspect, the SAS master can select a representative having an expertise in a particular subject matter domain as may be noted in an electronic database listing representatives and subject matter expertise of each representative. The subject matter domain can be one that is determined by the particular department in which the user is determined to have paused, by the particular department that is associated with the high value item, by the particular department that is associated with the item removed from the shopping cart as may be specified in an inventory management system available to the SAS, etc. In another example, a representative can be selected that has interacted with the customer on at least one prior occasion.

In step 720, the SAS can notify the selected representative of the customer that is in need of assistance. The SAS, for example, can provide the representative with the location of the customer, which can be updated as the customer continues to move throughout the store, the name or other identifying information for the customer, e.g., a picture, or the like. It should be appreciated that the notification can be provided through any of a variety of different communication channels, e.g., a text message to a mobile device used by the selected representative, an automated call to a mobile telephone carried by the selected representative, an electronic mail to the selected representative, or another form of notification delivered to an SAS client that may be carried by the representative.

FIG. 7 provides one example of a method of helping customers through the allocation or assignment of representatives of the store. Other techniques, however, also can be used. For example, the SAS can allow a representative to locate and/or identify a customer in need of assistance that is no longer at the particular location where the representative intervention condition was detected. If, for example, the user paused while looking at digital cameras, but moved to a different section of the store, a representative can query the SAS for customers suspected to be in need of assistance. The SAS can identify the customer to the representative and provide the representative with the current location of the customer so as to offer help.

The SAS can provide additional features relating to the closing or ending of the shopping experience. For example, responsive to determining that the customer is near finished shopping, e.g., has a full cart, has completed or nearly completed the shopping list, etc., the SAS can cause the SAS client to automatically rescan all items in the shopping cart and provide an updated list to the particular checkout station to which the customer is directed, e.g., by way of the SAS master being coupled to the checkout station. The customer can be presented at the checkout station with an up-to-date and accurate bill without having to manually scan or recheck the items placed in the shopping cart. Upon checkout, the SAS can complete the user session. Alternately the customer or a representative of the store can close the session.

It should be appreciated that any data generated during the current shopping session can be saved and become part of the shopping history of the customer that is available for use in subsequent visits by the customer. Further, data can be generated on a logical level so that location specific data can be correlated to specific departments or subject matter domains so that data generated at one branch of a store can be utilized, at least in part, at other branches (store locations) despite the physical layout one branch differing from another. Thus, a specific route taken in one branch of the store can be evaluated in terms of the departments visited or products visited by the customer for better use and application at another branch of the store.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1. A method of on-premise customer support, the method comprising:
responsive to logging a customer into a computerized shopping system on-premises of a store, recalling a shopping list associated with the customer; and
automatically generating, using a processor, a route through the store according to at least one item on the shopping list.

2. The method of claim 1, further comprising:
modifying the route while the customer is on-premises of the store responsive to at least one route update condition.

3. The method of claim 2, wherein the at least one route update condition comprises a condition external to the store.

4. The method of claim 3, wherein the condition external to the store comprises a weather condition associated with the store.

5. The method of claim 2, wherein the at least one route update condition comprises a condition within the store.

6. The method of claim 5, wherein the condition within the store comprises a minimum amount of congestion within the store at a location on the route.

7. The method of claim 2, wherein the at least one route update condition comprises identifying a high value item in a shopping cart associated with the customer.

8. The method of claim 2, wherein the at least one route update condition comprises a parameter entered into the computerized shopping system while the customer is on-premises of the store.

9. The method of claim 1, further comprising:
responsive to detecting a representative intervention condition for the customer while on-premises of the store, notifying a representative that the customer is in need of assistance.

10. The method of claim 9, wherein the representative intervention condition comprises detecting a pause of the customer at a location along the route on-premises of the store.

11. The method of claim 10, further comprising:
correlating the location with a subject matter domain; and
selecting a representative having expertise in the subject matter domain, wherein the notifying a representative that the customer is in need of assistance notifies the selected representative.

12. The method of claim 9, wherein the representative intervention condition comprises removing an item from a shopping cart associated with the customer.

13. The method of claim 1, further comprising:
associating the shopping list with an additional customer on-premises of the store; and
synchronizing the shopping list between the customer and the additional customer responsive to at least one of the customers selecting an item on the shopping list for purchase.

14. A method of collaborative shopping, the method comprising:
associating a shopping list with each of a plurality of customers;
determining that at least one of the plurality of customers has selected an item for purchase from the shopping list; and
using a processor, synchronizing the shopping list among the plurality of customers associated with the shopping list.

15. The method of claim 14, further comprising:
generating a different route through the store for each of the plurality of customers according to at least one parameter.

16. The method of claim 15, wherein the at least one parameter comprises a preference to generate routes to complete the shopping list in a least amount of time.

17. The method of claim 15, wherein the at least one parameter comprises a preference to generate routes according to customer-specific information for each of the plurality of customers.

18. A system comprising:
a processor configured to initiate executable operations comprising:
responsive to logging a customer into a computerized shopping system on-premises of a store, recalling a shopping list associated with the customer; and
automatically generating a route through the store according to at least one item on the shopping list.

19. The system of claim 18, wherein the processor is further configured to initiate an executable operation comprising:
modifying the route while the customer is on-premises of the store responsive to at least one route update condition.

20. A computer program product for on-premise customer support, the computer program product comprising:
a computer readable storage medium having computer readable program code embodied therewith, the computer readable program code comprising:
computer readable program code configured to, responsive to logging a customer into a computerized shopping system on-premises of a store, recall a shopping list associated with the customer; and
computer readable program code configured to automatically generate a route through the store according to at least one item on the shopping list.

21. The computer program product of claim 20, further comprising:
computer readable program code configured to modify the route while the customer is on-premises of the store responsive to at least one route update condition.

22. The computer program product of claim 21, wherein the at least one route update condition comprises a condition external to the store.

23. The computer program product of claim 21, wherein the at least one route update condition comprises a condition within the store.

24. The computer program product of claim 21, wherein the at least one route update condition comprises identifying a high value item in a shopping cart associated with the customer.

25. The computer program product of claim 20, further comprising:
computer readable program code configured to notify a representative that the customer is in need of assistance responsive to detecting a representative intervention condition for the customer while on-premises of the store.
